(19) United States
(12) Patent Application Publication
(10) Pub. No.: US 2016/0249681 A1
(43) Pub. Date: Sep. 1, 2016

(54) ELECTRONIC CIGARETTE AND ATOMIZING DEVICE THEREOF

(71) Applicant: KIMREE HI-TECH INC., RoadTown, Tortola (VG)

(72) Inventor: Qiuming LIU, Huizhou, Guangdong (CN)

(73) Assignee: KIMREE HI-TECH INC., RoadTown, Tortola (VG)

(21) Appl. No.: 14/651,927

(22) PCT Filed: Dec. 16, 2013
(86) PCT No.: PCT/CN2013/089534

§ 371 Date: Jun. 12, 2015

(30) Foreign Application Priority Data
Nov. 18, 2013 (CN) 201320729463.2

(51) Int. Cl. A24F 47/00; H05B 3/14; H05B 3/00

(52) U.S. Cl. CPC A24F 47/008; H05B 3/0014; H05B 3/141

(57) ABSTRACT

An electronic cigarette and an atomizing device of the electronic cigarette are provided. The atomizing device is assembled with a battery assembly to form an electronic cigarette. The atomizing device includes a heating member formed by a heating wire and a fixation mechanism for the heating wire. The fixation mechanism for the heating wire is a ceramic fixation mechanism. The ceramic fixation mechanism includes a ceramic base and a ceramic cap, which are made of a ceramic material or surfaces of which are ceramic material layers. The ceramic base is provided with a groove in connection with an end portion of the ceramic base. The ceramic cap is mounted on the ceramic base and covers the groove. The heating wire is mounted on the ceramic base and is located in a space enclosed by the ceramic cap and the groove.

This application claims the benefit of priority to Chinese Patent Application No. 201320729463.2 titled “ELECTRONIC CIGARETTE AND ATOMIZING DEVICE THEREOF”, filed with State Intellectual Property Office of the People's Republic of China on Nov. 18, 2013, which is incorporated herein by reference in its entirety.

### FIELD

The present disclosure relates to the technical field of electronic cigarette, in particular, to an electronic cigarette and an atomizing device thereof.

### BACKGROUND

The electronic cigarette, which is a common electronic product simulating the cigarette, mainly includes a liquid storage cotton, an atomizing device and a battery. The battery provides power to the atomizing device to make the atomizing device heat up, and the oil in the liquid storage cotton is vaporized to aerosolize in fumes, thereby achieving an effect of cigarette simulation.

An atomizer includes a heating wire and a fixation mechanism for the heating wire. Currently, in the atomizer, especially in a transparent atomizer, the fixation mechanism for the heating wire is a silica gel mechanism; that is, the heating wire of the atomizer is fixed on the silica gel mechanism.

However, since silica gel has a poor heat-resistance performance and generally may not withstand temperatures above 200 degrees, the silica gel may be carbonized and produce powder in a case that the heating wire is in high temperature. When a user sucks the electronic cigarette, the powder is apt to be inhaled into the body of the user along a suction airflow, thereby causing serious threats and harms to human health.

Therefore, how to reduce or even avoid impacts on human health due to carbonization of the silica gel in the electronic cigarette is an urgent problem to be solved by those skilled in the art.

### SUMMARY

An electronic cigarette and an atomizing device thereof are provided according to embodiments of the present disclosure. By replacing the silica gel mechanism with a ceramic mechanism to fix the heating wire, impacts on human health due to carbonization of the silica gel in the conventional electronic cigarette may be avoided.

An atomizing device according to an embodiment of the disclosure is assembled with a battery assembly to form an electronic cigarette. The atomizing device includes a heating member formed by a heating wire and a fixation mechanism for the heating wire.

The fixation mechanism for the heating wire is a ceramic fixation mechanism.

The ceramic fixation mechanism includes a ceramic base and a ceramic cap, which are made of a ceramic material or surfaces of which are ceramic material layers. The ceramic base is provided with a groove in connection with an end portion of the ceramic base. The ceramic cap is mounted on the ceramic base and covers the groove. The heating wire is mounted on the ceramic base and is located in a space enclosed by the ceramic cap and the groove.

Optionally, the ceramic cap is accommodated in the groove, and is located at one end of the ceramic base.

Optionally, a perforation for being penetrated through by the heating wire is provided on a groove wall of the groove, the groove wall being opposite to the ceramic cap and the perforation being in communication with one end of the ceramic base.

Optionally, the atomizing device further includes an outer electrode and an inner electrode which are coaxially nested and are for being electrically connected with the battery assembly. The ceramic base is inserted in one end of the outer electrode and is in contact with the inner electrode.

Optionally, the atomizing device further includes a transparent external tube and a transparent oil cup. The transparent oil cup and the ceramic fixation mechanism are coaxially arranged and are both provided in the external tube.

Optionally, a smoke passage is provided in the oil cup. The smoke passage penetrates through two ends of the oil cup and is in communication with the groove. An elastic sealed tube is sleeved on one end of the smoke passage and abuts against the ceramic cap.

Optionally, the ceramic base is a prism;

the ceramic cap is a prism or a cylinder; and

a shape of the ceramic cap fits with a shape of the groove.

Optionally, retaining portions are provided at the outside of the ceramic base and are for fixing the ceramic fixation mechanism.

Optionally, the retaining portions are provided at symmetric positions on the outside of the ceramic base.

An electronic cigarette according to an embodiment of the present disclosure includes an atomizing device and a battery assembly, the atomizing device being the atomizing device described above.

In the atomizing device and the electronic cigarette provided in the present disclosure, the ceramic fixation mechanism with good heat-resistance is used as the fixation mechanism for the heating wire; hence, impacts on human health due to carbonization of silica gel of the conventional electronic cigarette may be avoided, thereby increasing the security in using the electronic cigarette. Furthermore, since the heating wire is mounted on the ceramic base and is located in the space enclosed by the ceramic cap and the groove, the assembly efficiency may be increased, and the heating wire is fixed more stably and reliably, thereby avoiding the heating wire from falling off because of, for example, vibrations during transportation or usage.

### BRIEF DESCRIPTION OF THE DRAWINGS

To more clearly illustrate technical solutions in embodiments of the present disclosure or conventional technologies, brief description is made for drawings to be used in descriptions of the embodiments or the conventional technologies. Obviously, the drawings in the following description are only for some embodiments of the present disclosure. For those skilled in the art, other drawings may be further obtained based on the drawings without creative efforts.

FIG. 1 is a structural schematic diagram of an atomizing device according to an embodiment of the present disclosure, where a fiberglass line is inserted in a heating member;

FIG. 2 is a structural schematic diagram of a ceramic cap of an atomizing device according to an embodiment of the present disclosure;

FIG. 3 is a structural schematic diagram of a ceramic base of an atomizing device according to an embodiment of the present disclosure;

FIG. 4 is a schematic sectional view of an atomizing device according to an embodiment of the present disclosure; and

FIG. 5 is an exploded view of a structure of an atomizing device according to an embodiment of the present disclosure.

### DETAILED DESCRIPTION OF THE EMBODIMENTS

An electronic cigarette and an atomizing device thereof are provided according to embodiments of the present disclosure. By replacing the silica gel mechanism with a ceramic mechanism to fix the heating wire, impacts on human health due to carbonization of the silica gel in the conventional electronic cigarette may be avoided.

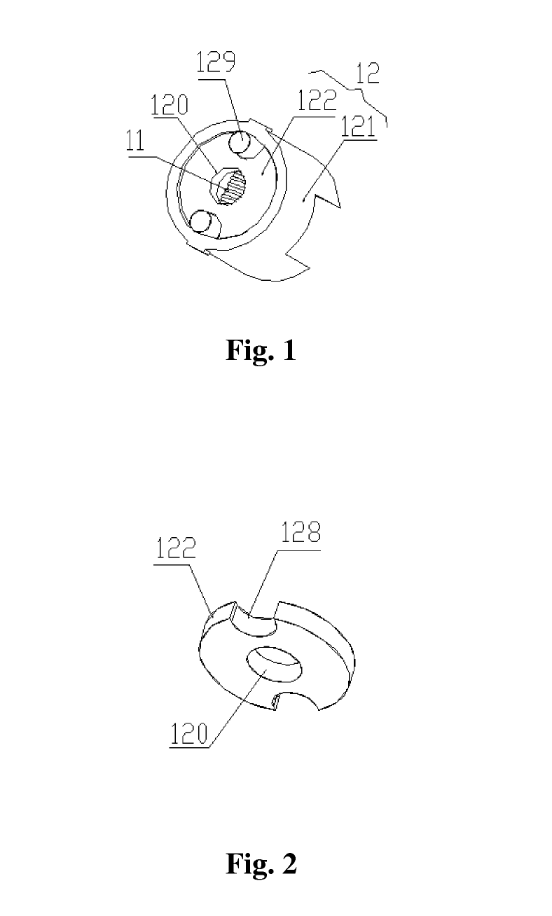

A technical solution according to the embodiments of the disclosure is clearly detailed hereinafter in conjunction with drawings in the embodiments of the disclosure. Obviously, the described embodiments are merely a part of rather than all of the embodiments of the present disclosure. All other embodiments made by those skilled in the art based on the embodiments of the present disclosure without creative efforts fall within the scope of protection of the present disclosure. FIG. 1 shows an atomizing device according to an embodiment of the present disclosure. The atomizing device may be assembled with a battery assembly to form an electronic cigarette. The atomizing device includes a heating member formed by a heating wire 11 and a fixation mechanism for the heating wire.

The fixation mechanism for the heating wire is a ceramic fixation mechanism 12.

The ceramic fixation mechanism 12 includes a ceramic base 121 and a ceramic cap 122, which are made of a ceramic material or surfaces of which are ceramic material layers. The ceramic base 121 is provided with a groove 123 in connection with an end portion of the ceramic base 121. The ceramic cap 122 is mounted on the ceramic base 121 and covers the groove 123. The heating wire 11 is mounted on the ceramic base 121 and located in a space enclosed by the ceramic cap 122 and the groove 123.

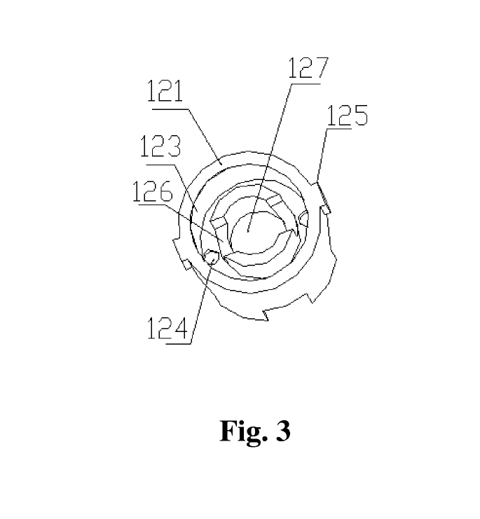

In the atomizing device provided in the present disclosure, the heating member includes the ceramic fixation mechanism 12 and the heating wire 11, and the ceramic fixation mechanism 12 is for fixing the heating wire 11. Reference may be made to FIGS. 2, 3 and 4, where FIG. 2 is a schematic structural diagram of the ceramic cap 122, and FIG. 3 is a schematic structural diagram of the ceramic base 121. The ceramic base 121 is provided with the groove 123 in connection with the end portion of the ceramic base 121. The ceramic cap 122 is mounted on the ceramic base 121 and covers the groove 123. The heating wire 11 is mounted on the ceramic base 121 and located in the space enclosed by the ceramic cap 122 and the groove 123. A stuck groove fitting with the heating wire 11 may be provided on the ceramic cap 122, thereby indirectly fixing the heating wire 11 by fixing the ceramic cap 122.

In the embodiment, in the ceramic base 121, a stuck groove 126 fitting with the heating wire 11 is provided at a bottom wall of the groove 123; hence, the heating wire 11 may be fixed in the ceramic base 121. Particularly in the embodiment, an air hole 127 is provided in an axial direction of the ceramic base 121, the air hole 127 extending into the groove 123 and extending to an end surface of the ceramic base 121. Two U-shaped stuck grooves 126 are provided at the bottom wall of the groove 123 and are symmetrically arranged on two sides of the air hole 127, where the stuck grooves 126 fit with a shape of the heating wire 11 and retain two ends of the heating wire 11. If the heating wire 11 is in other shape, the stuck grooves 126 in the ceramic base 121 may be adjusted adaptively based on the shape of the heating wire 11.

Optionally, the ceramic cap 122 is accommodated in the groove 123 and located at one end of the ceramic base 121. Since the ceramic cap 122 may be directly accommodated in a space of the groove 123 in the ceramic body 121, that is, no connection structure between the ceramic cap 122 and the ceramic base 121 is further required, the assembly efficiency may be improved and the structure compactness may be enhanced. Two gaps 128 are symmetrically provided at a circumference of the ceramic cap 122. A fiberglass line 129 of the atomizing device, for guiding oil, extends out through the gaps 128. The heating wire 11 is wound on the fiberglass line 129 for atomizing the oil on the fiberglass line 129. A through hole 120 is provided at a central part of the ceramic cap 122, for exhausting smoke in the groove 123.

Optionally, a perforation 124 through which the heating wire 11 may penetrate is provided on a groove wall of the groove 123, where the groove wall is opposite to the ceramic cap 122 and the perforation 124 is in connection with one end of the ceramic base 121. For example, two perforations 124 may be symmetrically provided on the groove wall, and lines connected to the heating wire 11 may penetrate through the two perforations 124. With this design in replace of a layout that the heating wire is arranged on a side wall of the ceramic base, oil leakage from a gap formed by the layout that the heating wire is arranged on the side wall of the ceramic base may be avoided, and a non-ceramic material of the side wall of the ceramic base may be prevented from being burnt by the heating wire in contact with the non-ceramic material.

Optionally, the atomizing device further includes an outer electrode 13 and an inner electrode 14, which are coaxially nested and for being electrically connected with the battery assembly. The ceramic base 121 is inserted into one end of the outer electrode 13 and is in contact with the inner electrode 14. The outer electrode 13 is provided with an air intake hole 131 in communication with the air hole 127. The outer electrode 13 and the inner electrode 14 are made of a metallic material and are both good heat conductors. Hence, the heat of the ceramic base may be conducted out through the outer electrode 13, and the heat is avoided from accumulating on the ceramic base to scald a hand.

Optionally, the atomizing device further includes a transparent external tube 15, and a transparent oil cup 16 for conveying oil to the fiberglass line 129. The oil cup 16 and the ceramic fixation mechanism 12 are coaxially arranged and both provided in the external tube 15. With the design of the transparent external tube 15 and the transparent oil cup 16, a user may conveniently observe an amount of the oil; therefore, a continuation of smoking in case of no oil, which may cause the fiberglass line 129 burnt by the heating wire 11, may be prevented. In the embodiment, the external tube 15 includes a first tube 151 and a second tube 152 which are arranged coaxially. The first tube 151 is sleeved on the oil cup 16. The second tube 152 is sleeved on one end of the oil cup 16 and on the outer electrode 13. A layer of paster 18 is coated on a circumferencial surface of the outer tube 15, to mimic the cigarette and to improve the user experience.

Optionally, a smoke passage 161 is provided in the oil cup 16, the smoke passage 161 penetrating through two ends of the oil cup 16 and being in communication with the groove 123. An elastic sealed tube 17 is sleeved on one end of the smoke passage 161 and abuts against the ceramic cap 122. The elastic sealed tube 17 is designed to prevent the oil from entering the smoke passage, thereby avoiding a user from inhaling the oil in a suction. In addition, with the design, the ceramic cap 122 and the heating wire 11 are fixed more reliably. When smoking, an air flow enters the air intake hole 131 of the outer electrode 13, passes through the air hole 127, and enters the groove 123; then the air flow is mixed with smoke in the groove 123, and the mixture is inhaled into the mouth of a smoker through the smoke passage 161. With the air intake hole 131 provided on the outer electrode 13 and the air hole 127 provided on the ceramic base 121, temperatures of the outer electrode 13 and the ceramic base 121 may be decreased, thereby avoiding an accumulation of heat during smoking, which may scald a hand In addition, a temperature of the smoke may be increased to be close to a temperature of tobacco combustion, thereby improving the user experience.

Optionally, the ceramic base 121 is a prism;

the ceramic cap 122 is a prism or a cylinder; and

a shape of the ceramic cap 122 fits with a shape of the groove 123.

The ceramic base 121 may be a prism. The ceramic cap 122 may be a prism or a cylinder. A groove fitting with the ceramic cap 122 is provided on the ceramic base 121. The ceramic base 121 is the prism; hence, a heating mechanism is fixed in the electronic cigarette, and it is ensured that the heating mechanism may not rotate, thereby improving the security in using the electronic cigarette. The ceramic cap 122 may be a prism, a cylinder, or may be in other shapes, which is not limited herein. The groove fitting with the ceramic cap 122 is provided on the ceramic base 121, to fix the ceramic cap 122.

Specifically, the ceramic base 121 may be an octagonal prism, and the ceramic cap 122 may be an octagonal prism or a cylinder.

Optionally, retaining portions 125 are provided at the outside of the ceramic base 121, for fixing the ceramic fixation mechanism 12.

Optionally, the retaining portions 125 are provided at symmetric positions on the outside of the ceramic base 121.

To further optimize the above technical solution, retaining notches 132 are provided on one end of the outer electrode 13, positions of the retaining notches 132 corresponding to positions of the retaining portions. The retaining portions 125 are retained in the retaining notches 132, to fix the ceramic fixation mechanism 12 in the outer electrode 13.

In the atomizing device provided in the present disclosure, the ceramic fixation mechanism 12 with good heat-resistance is used as the fixation mechanism for the heating wire 11; hence, impacts on human health due to carbonization of silica gel of a conventional atomizing device may be avoided, thereby increasing the security in suing the atomizing device of the electronic cigarette. In addition, the design of the transparent external tube 15, the transparent oil cup 16 and the elastic sealed tube 17 may further enhance practicability of the atomizing device provided in the present disclosure.

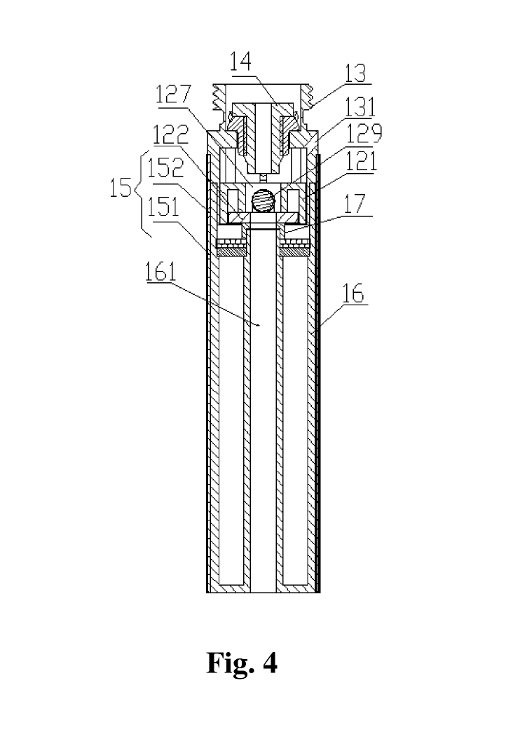

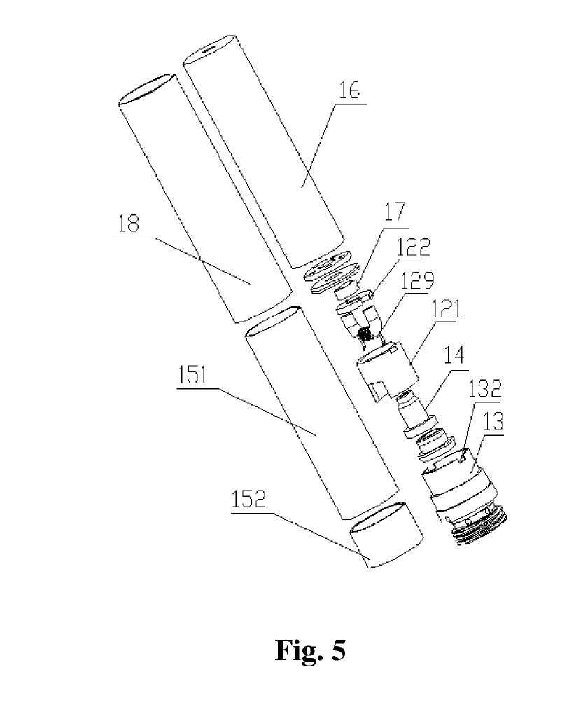

The atomizing device according to the embodiment of the disclosure is described briefly hereinabove. An electronic cigarette according to an embodiment of the disclosure is detailed hereinafter. Reference may be made to FIGS. 4 and 5, the electronic cigarette according to the embodiment of the disclosure includes:

an atomizing device and a battery assembly; the atomizing device is the atomizing device described above, which is not detailed herein; the battery assembly is for being connected to the atomizing device and for supplying power to the atomizing device; the battery assembly is provided with a battery, and a controlling module for controlling the battery to supply power to the atomizing device; the battery assembly is an conventional technology and is not detailed herein; in the embodiment, the atomizing device and the battery assembly are detachably connected; it is understood that the atomizer device and the battery assembly may be an integral structure which is non-detachable.

In summary, in the atomizing device and the electronic cigarette formed by the atomizing device and the battery assembly provided in the disclosure, the ceramic fixation mechanism 12 with good heat-resistance is used as the fixation mechanism for the heating wire; hence, impacts on human health due to carbonization of silica gel of a conventional electronic cigarette may be avoided, thereby increasing the security in using the electronic cigarette. Furthermore, since the heating wire 11 is mounted on the ceramic base 121 and is located in the space enclosed by the ceramic cap 122 and the groove 123, the assembly efficiency may be increased, and the heating wire 11 is fixed more stably and reliably, thereby avoiding the heating wire 11 from falling off because of, for example, vibrations during transportation or usage.

The electronic cigarette and the atomizing device thereof provided in the present disclosure are described above in details. The principles and the embodiments of the present disclosure are described with specific examples. The above description of the embodiment is only used to help understanding the method and core ideas of the present disclosure. It should be noted that, a number of improvements and modifications may be made to the disclosure by those skilled in the art without departing from the principles of the present disclosure, and the improvements and modifications fall within the scope of protection of the disclosure defined by the claims.

In the claims:

1. An atomizing device, which is assembled with a battery assembly to form an electronic cigarette, wherein the atomizing device comprises a heating member formed by a heating wire and a fixation mechanism for the heating wire;
the fixation mechanism for the heating wire is a ceramic fixation mechanism;
the ceramic fixation mechanism comprises a ceramic base and a ceramic cap, which are made of a ceramic material or surfaces of which are ceramic material layers; the ceramic base is provided with a groove in connection with an end portion of the ceramic base; the ceramic cap is mounted on the ceramic base and covers the groove; and the heating wire is mounted on the ceramic base and is located in a space enclosed by the ceramic cap and the groove.

2. The atomizing device according to claim 1, wherein:
the ceramic cap is accommodated in the groove and is located at one end of the ceramic base.

3. The atomizing device according to claim 1, wherein a perforation, configured to be penetrated through by the heating wire, is provided on a groove wall of the groove, the groove wall being opposite to the ceramic cap and the perforation being in connection with one end of the ceramic base.

4. The atomizing device according to claim 1, wherein the atomizing device further comprises an outer electrode and an inner electrode which are coaxially nested and are configured to be electrically connected with the battery assembly, and the ceramic base is inserted in one end of the outer electrode and is in contact with the inner electrode.

5. The atomizing device according to claim 1, wherein the atomizing device further comprises a transparent external tube and a transparent oil cup, the oil cup and the ceramic fixation mechanism are coaxially arranged and are both provided in the external tube.

6. The atomizing device according to claim 5, wherein a smoke passage is provided in the oil cup, the smoke passage penetrating through two ends of the oil cup and being in communication with the groove, and an elastic sealed tube is sleeved on one end of the smoke passage and abuts against the ceramic cap.

7. The atomizing device according to claim 2, wherein:
the ceramic base is a prism;
the ceramic cap is a prism or a cylinder; and
a shape of the ceramic cap fits with a shape of the groove.

8. The atomizing device according to claim 1, wherein:
retaining portions are provided at the outside of the ceramic base and are configured to fix the ceramic fixation mechanism.

9. The atomizing device according to claim 8, wherein:
The retaining portions are provided at symmetric positions on the outside of the ceramic base.

10. An electronic cigarette, comprising an atomizing device and a battery assembly, wherein:
the atomizing device comprises a heating member formed by a heating wire and a fixation mechanism for the heating wire;
the fixation mechanism for the heating wire is a ceramic fixation mechanism;
the ceramic fixation mechanism comprises a ceramic base and a ceramic cap, which are made of a ceramic material or surfaces of which are ceramic material layers; the ceramic base is provided with a groove in connection with an end portion of the ceramic base; the ceramic cap is mounted on the ceramic base and covers the groove; and the heating wire is mounted on the ceramic base and is located in a space enclosed by the ceramic cap and the groove.

11. The electronic cigarette according to claim 10, wherein the ceramic cap is accommodated in the groove and is located at one end of the ceramic base.

12. The electronic cigarette according to claim 10, wherein a perforation, configured to be penetrated through by the heating wire, is provided on a groove wall of the groove, the groove wall being opposite to the ceramic cap and the perforation being in connection with one end of the ceramic base.

13. The electronic cigarette according to claim 10, wherein the atomizing device further comprises an outer electrode and an inner electrode which are coaxially nested and are configured to be electrically connected with the battery assembly, and the ceramic base is inserted in one end of the outer electrode and is in contact with the inner electrode.

14. The electronic cigarette according to claim 10, wherein the atomizing device further comprises a transparent external tube and a transparent oil cup, the oil cup and the ceramic fixation mechanism are coaxially arranged and are both provided in the external tube.

15. The electronic cigarette according to claim 14, wherein a smoke passage is provided in the oil cup, the smoke passage penetrating through two ends of the oil cup and being in communication with the groove, and an elastic sealed tube is sleeved on one end of the smoke passage and abuts against the ceramic cap.

16. The electronic cigarette according to claim 11, wherein:
the ceramic base is a prism;
the ceramic cap is a prism or a cylinder; and
a shape of the ceramic cap fits with a shape of the groove.

17. The electronic cigarette according to claim 10, wherein:
retaining portions are provided at the outside of the ceramic base and are configured to fix the ceramic fixation mechanism.

18. The electronic cigarette according to claim 17, wherein:
The retaining portions are provided at symmetric positions on the outside of the ceramic base.
